(19) United States
(12) Patent Application Publication
(10) Pub. No.: US 2003/0229952 A1
(43) Pub. Date: Dec. 18, 2003

(54) Mixtures of fiber-reactive bisazo dyes and use thereof

(76) Inventors: Joachim Eichhorn, Frankfurt (DE); Uwe Mrotzeck, Kelkheim (DE); Werner Russ, Florsheim-Wicker (DE)

Correspondence Address: Ashley I. Pezzner, Esquire, CONNOLLY BOVE LODGE & HUTZ LLP, 1220 Market Street, P.O. Box 2207, Wilmington, DE, 19899, US

(21) Appl. No.: 10/301,419

(22) Filed: Nov. 21, 2002

(30) Foreign Application Priority Data
Dec. 1, 2001 (DE) 101 59 085.7

(51) Int. Cl. C09B 62/00

(52) U.S. Cl. 8/687; 8/543

(57) ABSTRACT

Reactive dye mixtures including one or more disazo dyes of the hereinbelow indicated and defined general formula (I)

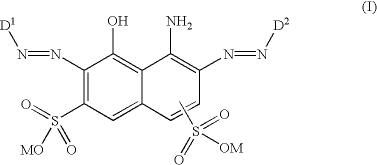

and one or more disazo dyes of the hereinbelow indicated and defined general formula (II)

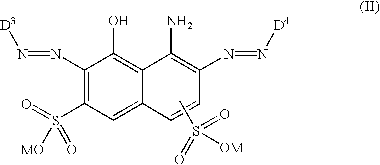

where D¹, D², D³, D⁴ and M are each as defined in claim 1.

### This invention relates to the technical field of fiber-reactive azo dyes.

Fiber-reactive disazo dyes and their use for dyeing hydroxyl- and carboxamido-containing material in navy hues have been extensively described and are known for example from U.S. Pat. No. 2,657,205, the Japanese patent application publication Sho-58-160 362, and U.S. Pat. No. 4,257,770.

However, the dyes have in some instances certain application defects, for example an insufficient color build-up on cotton (good color build-up results from the ability of a dye to provide a proportionally stronger dyeing when used in higher concentrations in the dyebath) or an overly large dependence of the color yield on varying dyeing parameters in the dyeing process. In addition, individual fastnesses of the dyeings obtained, for example the lightfastnesses, are in some instances not up to present day requirements.

There consequently continues to be a demand for novel reactive dyes, or reactive dye mixtures, having improved properties, such as high substantivity coupled with good wash-off properties with regard to unfixed portions. They shall moreover provide good dyeing yields and possess high reactivity and they shall more particularly provide dyeings having high degrees of fixation and good lightfastness.

The present invention, then, provides dye mixtures which possess these above-described properties to a high degree. These novel dye mixtures are notable in particular for high color strength, high yields of fixation, good build-up and easy wash-off of portions not fixed on the fiber. In addition, the dyeings possess very good general fastnesses, such as high lightfastness and good wetfastnesses.

This invention accordingly provides mixtures of disazo dyes of the hereinbelow indicated and defined general formula (I) with one or more, such as one, two or three, dyes of the general formula (II)

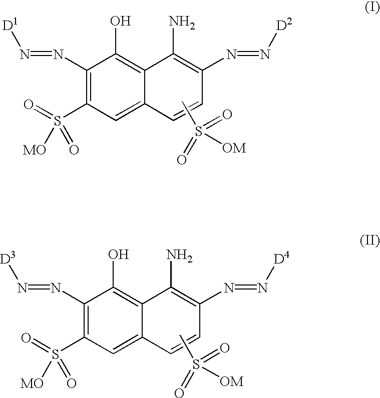

where

D¹ is a group of the general formula (I-1) and D² is a group of the general formula (I-2)

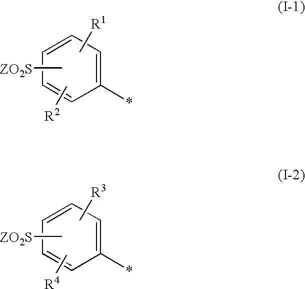

D³ is a group of the general formula (II-1) and D⁴ is a group of the general formula (II-2)

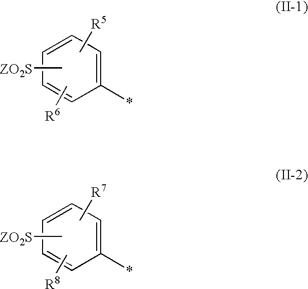

where

R¹ and R² are independently hydrogen, (C₁-C₄)-alkyl, (C₁-C₄)-alkoxy, sulfo or carboxyl;

R³ is hydrogen, (C₁-C₄)-alkyl or (C₁-C₄)-alkoxy;

R⁴ is (C₁-C₄)-alkyl or (C₁-C₄)-alkoxy;

R⁵, R⁶, R⁷ and R⁸ are independently hydrogen, (C₁-C₄)-alkyl, (C₁-C₄)-alkoxy, hydroxyl, sulfo, carboxyl, cyano, nitro or halogen;

Z is —CH₂CH₂Z¹ or —CH═CH₂, where

Z¹ is an alkali-detachable group or hydroxyl; and

M is hydrogen, an alkali metal or one equivalent of an alkaline earth metal.

The individual symbols in the general formulae above and below can have identical or different meanings under their definition, irrespective of whether the symbols bear the same or a different designation.

R¹ and R² are each preferably hydrogen, (C₁-C₄)-alkyl groups or (C₁-C₄)-alkoxy groups and more preferably methyl or methoxy.

R³ is preferably hydrogen, methyl or methoxy and more preferably methyl or methoxy. R⁴ is more preferably methoxy. R⁵ to R⁸ are each preferably hydrogen, (C₁-C₄)-alkyl, (C₁-C₄)-alkoxy, sulfo and carboxyl. R⁵ and R⁶ are more preferably hydrogen, methyl, methoxy or sulfo and R⁷ and R⁸ are more preferably hydrogen or sulfo.

(C₁-C₄)-Alkyl groups can be straight-chain or branched and be in particular methyl, ethyl, n-propyl, i-propyl, n-butyl, i-butyl, sec-butyl and tert-butyl. Methyl and ethyl are preferred and methyl is particularly preferred. The same logic applies to (C₁-C₄)-alkoxy groups.

Halogen R⁵, R⁶, R⁷ or R⁸ is in particular fluorine, chlorine and bromine, of which chlorine and bromine are preferred.

Alkali-eliminable Z¹ in the β-position of the ethyl group of Z include for example halogen atoms, such as chlorine and bromine, ester groups of organic carboxylic and sulfonic acids, as of alkylcarboxylic acids, substituted or unsubstituted benzenecarboxylic acids and substituted or unsubstituted benzenesulfonic acids, such as alkanoyloxy of 2 to 5 carbon atoms, especially acetyloxy, benzoyloxy, sulfobenzoyloxy, phenylsulfonyloxy and toluylsulfonyloxy, also acidic ester groups of inorganic acids, as of phosphoric acid, sulfuric acid and thiosulfuric acid (phosphato, sulfato and thiosulfato groups), similarly dialkylamino groups having alkyl groups of 1 to 4 carbon atoms in each case, such as dimethylamino and diethylamino.

Z is preferably vinyl, β-chloroethyl and more preferably β-sulfatoethyl.

The groups “sulfo”, “carboxyl”, “thiosulfato”, “phosphato” and “sulfato” include not only their acid form but also their salt form. Accordingly, sulfo groups are groups conforming to the general formula —SO₃M, thiosulfato groups are groups conforming to the general formula —S—SO₃M, carboxyl groups are groups conforming to the general formula —COOM, phosphato groups are groups conforming to the general formula —OPO₃M₂ and sulfato groups are groups conforming to the general formula —OSO₃M, in each of which M is as defined above.

The dyes of the general formulae (I) and (II) may possess different fiber-reactive groups —SO₂Z within the meaning of Z in D¹ to D⁴. More particularly, the fiber-reactive groups —SO₂Z may be on the one hand vinylsulfonyl groups and on the other —CH₂CH₂Z¹ groups, preferably β-sulfatoethylsulfonyl groups. If the dyes of the general formulae (I) and (II) contain vinylsulfonyl groups in some instances, then the fraction of the respective dye with the vinylsulfonyl group is up to about 30 mol %, based on the respective amount of total dye.

Alkali M is in particular lithium, sodium or potassium. M is preferably hydrogen or sodium.

In the general formulae (1-1), (I-2), (II-1) and (II-2), the SO₂Z groups are each preferably attached to the benzene nucleus in a position meta or para relative to the azo group.

Examples of components D¹ to D⁴ of the general formulae (I) and (II) are 2-(β-sulfato-ethylsulfonyl )-phenyl, 3-(β-sulfatoethylsulfonyl )-phenyl, 4-(β-sulfatoethylsulfonyl)-phenyl, 2-carboxy-5-(β-sulfatoethylsulfonyl)-phenyl, 2-chloro-4-(β-sulfatoethyl-sulfonyl)-phenyl, 2-chloro-5-(β-sulfatoethylsulfonyl)-phenyl, 2-bromo-4-(β-sulfato-ethylsulfonyl)-phenyl, 2-sulfo-4-(β-sulfatoethylsulfonyl)-phenyl, 2-sulfo-5-(β-sulfato-ethylsulfonyl )-phenyl, 2-methoxy-5-(β-sulfatoethylsulfonyl)-phenyl, 2-ethoxy-5-(β-sulfatoethylsulfonyl)-phenyl, 2,5-dimethoxy-4-(β-sulfatoethylsulfonyl)-phenyl, 2-methoxy-5-methyl-4-(β-sulfatoethylsulfonyl)-phenyl, 2-methyl-4-(β-sulfatoethyl-sulfonyl)-phenyl, 2- or 3- or 4-(β-thiosulfatoethylsulfonyl)-phenyl, 2-methoxy-5-(β-thiosulfatoethylsulfonyl)-phenyl, 2-sulfo-4-(β-phosphatoethylsulfonyl)-phenyl, 2- or 3- or 4-vinylsulfonyl-phenyl, 2-sulfo-4-vinylsulfonyl-phenyl, 2-chloro-4-(β-chloro-ethylsulfonyl)-phenyl, 2-chloro-5-(β-chloroethylsulfonyl)-phenyl, 3- or 4-(β-acetoxyethylsulfonyl)-phenyl, preferably 3-(β-sulfatoethylsulfonyl)-phenyl, 4-(β-sulfatoethylsulfonyl)-phenyl, 2-sulfo-4-(β-sulfatoethylsulfonyl)-phenyl, 2-methoxy-5-(β-sulfatoethylsulfonyl)-phenyl, 2,5-dimethoxy4-(β-sulfatoethylsulfonyl)-phenyl, 2-methoxy-5-methyl-4-(β-sulfatoethylsulfonyl)-phenyl and 3- or 4-vinylsulfonyl-phenyl.

Preferred mixtures include at least one dye of the general formula (Ia)

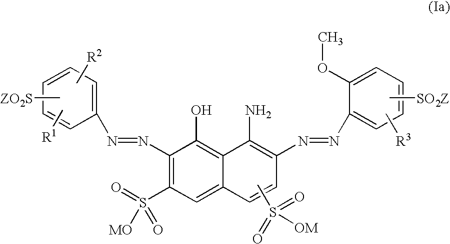

and one or more dyes of the general formula (IIa)

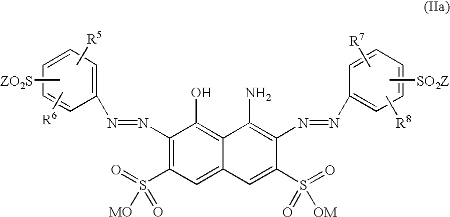

where M, R¹ to R³, R⁵ to R⁸ and Z are each as defined above.

In the general formula (Ia), R¹ to R³ are independently more preferably hydrogen, methyl or methoxy and Z is vinyl or β-sulfatoethyl; most preferably, R¹ to R³ are each methyl or methoxy and Z is vinyl or β-sulfatoethyl in the formula (Ia).

In the general formula (IIa), R⁵ to R⁸ are independently more preferably hydrogen, methyl, methoxy, sulfo or carboxyl and Z is vinyl or β-sulfatoethyl; most preferably, R⁵ and R⁶ are hydrogen, ethoxy or sulfo, R⁷ and R⁸ are each hydrogen or sulfo and Z is vinyl or β-sulfatoethyl in the formula (IIa).

The dye mixtures according to the invention include bisazo dyes of the general formula (I) in an amount of 5 to 95% by weight and preferably 10 to 90% by weight and bisazo dyes of general formula (II) in an amount of 5 to 95% by weight and preferably 10 to 90% by weight.

Optionally, the dye mixtures according to the invention may also include one or more monoazo dyes of the general formulae (1) or (2) in an amount of up to 10% by weight

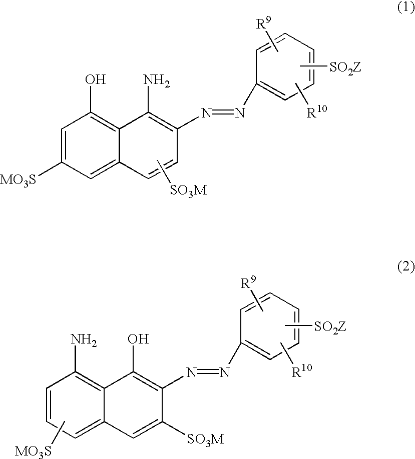

where M and Z are each as defined above and R⁹ has one of the meanings of R³ or R⁷ and R¹⁰ each have one of the meanings of R⁴ or R⁸.

More preferably, R⁹ and R¹⁰ are each hydrogen, methyl, methoxy or sulfo and Z is more preferably vinyl or β-sulfatoethyl.

Dyes of the general formulae (1) and (2) are obtainable via standard methods of synthesis or are in some instances formed during the synthesis of dyes of the general formula (I) and (II). They are customarily used as shading components.

The dye mixtures of the general formula (I) and (II) according to the invention can be present as a preparation in solid or liquid (dissolved) form. In solid form, they contain, to the extent necessary, the electrolyte salts customary in the case of water-soluble and especially fiber-reactive dyes, such as sodium chloride, potassium chloride and sodium sulfate, and may further contain the auxiliaries customary in commercial dyes, such as buffer substances capable of setting a pH in aqueous solution between 3 and 7, such as sodium acetate, sodium citrate, sodium borate, sodium bicarbonate, sodium dihydrogenphosphate and disodium hydrogenphosphate, dyeing auxiliaries, dustproofing agents and small amounts of siccatives; when they are present in a liquid, aqueous solution (including a content of thickeners of the type customary in print pastes), they may also contain substances which ensure a long life for these preparations, for example mold preventatives.

In solid form, the dye mixtures according to the invention are generally present as powders or granules which contain electrolyte salt and which will hereinbelow generally be referred to as a preparation with or without one or more of the abovementioned auxiliaries. In the preparations, the dyes of the general formulae (I) and (II) are present at 20 to 90% by weight, based on the preparation containing them. The buffer substances are generally present in a total amount of up to 5% by weight, based on the preparation.

When the dye mixtures according to the invention are present in an aqueous solution, the total dye content of these aqueous solutions is up to about 50% by weight, for example between 5 and 50%, the electrolyte salt content of these aqueous solutions preferably being up to 20% by weight, based on the aqueous solution; the aqueous solutions (liquid preparations) can contain the aforementioned buffer substances in an amount which is generally up to 5% by weight and preferably up to 2% by weight.

The dye mixtures according to the invention are preparable in a conventional manner, as by mechanically mixing the individual dyes, whether in the form of their dye powders or granules or their as-synthesized solutions or in the form of aqueous solutions of the individual dyes generally, which may additionally contain customary auxiliaries, or by conventional diazotization and coupling of suitable mixtures of diazo components and 1-amino-8-hydroxynaphthalene-3,6-disulfonic acid or 1-amino-8-hydroxynaphthalene-4,6-disulfonic acid as coupling components in the desired amount ratios.

For example, the dye mixture according to the invention where, in the diazo components, the groups R¹ and R⁵ and also R² and R⁶ as per the general formulae (I-1) and (II-1) have the same meanings can be prepared by diazotizing a mixture of amines of the general formulae (3a) and (3b)

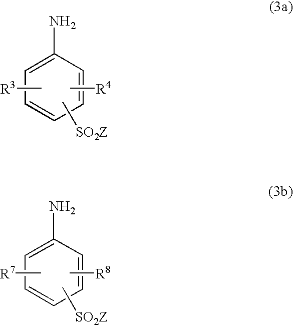

where R³, R⁴, R⁷, R⁸ and Z are each as defined above, in a conventional manner in an acidic medium and coupling the resulting mixture of diazonium compounds onto 1-amino-8-hydroxynaphthalene-3,6-disulfonic acid or 1-amino-8-hydroxynaphthalene-4,6-disulfonic acid at a pH below 2 in a first step to form a mixture of monoazo dyes and subsequently diazotizing an amine of the general formula (3c)

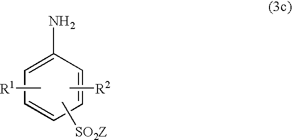

where R¹, R² and Z are each as defined above, in a conventional manner and reacting the resulting diazonium compound at a pH between 3 and 8 with the mixture of monoazo compounds which was obtained beforehand in the first step.

The dyes according to the invention are isolated in a conventional manner by salting out for example with sodium chloride or potassium chloride or by spray drying.

Similarly, the as-synthesized solutions of the dyes of the general formula (I) and (II) can be used directly as a liquid preparation for dyeing, if appropriate after addition of a buffer substance and if appropriate after concentrating.

Mixtures of dyes which as well as β-chloroethylsulfonyl or β-thiosulfatoethylsulfonyl or β-sulfatoethylsulfonyl groups also contain vinylsulfonyl groups as reactive radicals can not only be synthesized starting from appropriately substituted vinylsulfonyl-anilines, but also be obtained by reacting the mixture of dyes of the general formulae (I) and (II) where Z is β-chloroethyl, β-thiosulfatoethyl or β-sulfatoethyl with an amount of alkali required for the desired fraction and converting the β-substituted ethylsulfonyl groups mentioned into vinylsulfonyl groups. This conversion is effected in a manner familiar to one skilled in the art.

The dye mixtures according to the invention have useful application properties. They are used for dyeing or printing hydroxyl- and/or carboxamido-containing materials, for example in the form of sheetlike structures, such as paper and leather or of films, for example composed of polyamide, or in bulk, as for example polyamide and polyurethane, but especially for dyeing and printing these materials in fiber form. Similarly, the as-synthesized solutions of the dye mixtures according to the invention can be used directly as a liquid preparation for dyeing, if appropriate after addition of a buffer substance and if appropriate after concentration or dilution.

The present invention thus also provides for the use of the dye mixtures according to the invention for dyeing or printing these materials, or rather processes for dyeing or printing these materials in a conventional manner, by using the dye mixtures according to the invention as a colorant. The materials are preferably employed in the form of fiber materials, especially in the form of textile fibers, such as woven fabrics or yarns, as in the form of hanks or wound packages.

Hydroxyl-containing materials are those of natural or synthetic origin, for example cellulose fiber materials or their regenerated products and polyvinyl alcohols. Cellulose fiber materials are preferably cotton, but also other vegetable fibers, such as linen, hemp, jute and ramie fibers; regenerated cellulose fibers are for example staple viscose and filament viscose and also chemically modified cellulose fibers, such as aminated cellulose fibers or fibers as described for example in WO 96/37641 and WO 96/37642 and also in EP-A-0 538 785 and EP-A-0 692 559.

Carboxamido-containing materials are for example synthetic and natural polyamides and polyurethanes, especially in the form of fibers, for example wool and other animal hairs, silk, leather, nylon-6,6, nylon-6, nylon-11 and nylon-4.

The dye mixtures according to the invention can be applied to and fixed on the substrates mentioned, especially the fiber materials mentioned, by the application techniques known for water-soluble dyes and especially for fiber-reactive dyes. For instance, on cellulose fibers they produce by exhaust methods from a long liquor and also from a short liquor, for example in a liquor to goods ratio of 5:1 to 100:1, preferably 6:1 to 30:1, using various acid-binding agents and optionally neutral salts as far as necessary, such as sodium chloride or sodium sulfate, dyeings having very good color yields. Application is preferably from an aqueous bath at temperatures between 40 and 105° C., optionally at a temperature of up to 130° C. under superatmospheric pressure, but preferably at 30 to 95° C., especially 45 to 65° C., in the presence or absence of customary dyeing auxiliaries. One possible procedure here is to introduce the material into the warm bath and to gradually heat the bath to the desired dyeing temperature and complete the dyeing process at that temperature. The neutral salts which accelerate the exhaustion of the dyes may also if desired only be added to the bath after the actual dyeing temperature has been reached.

Padding processes likewise provide excellent color yields and a very good color build-up on cellulose fibers, the dyes being fixable in a conventional manner by batching at room temperature or elevated temperature, for example at up to 60° C., or in a continuous manner, for example by means of a pad-dry-pad steam process, by steaming or using dry heat.

Similarly, the customary printing processes for cellulose fibers, which can be carried out in one step, for example by printing with a print paste containing sodium bicarbonate or some other acid-binding agent and by subsequent steaming at 100 to 103° C., or in two steps, for example by printing with a neutral or weak acidic print color and then fixing either by passing the printed material through a hot electrolyte-containing alkaline bath or by overpadding with an alkaline electrolyte-containing padding liquor and subsequent batching of the alkali-overpadded material or subsequent steaming or subsequent dry heat treatment of the alkali-overpadded material, produce strong prints with well-defined contours and a clear white ground. The outcome of the prints is little affected, if at all, by variations in the fixing conditions.

When fixing by means of dry heat in accordance with the customary thermofix processes, hot air at 120 to 200° C. is used. In addition to the customary steam at 101 to 103° C., it is also possible to use superheated steam and high-pressure steam at temperatures of up to 160° C.

The acid-binding agents which effect the fixation of the dyes of the dye mixtures according to the invention on the cellulose fibers are for example water-soluble basic salts of alkali metals and likewise alkaline earth metals of inorganic or organic acids or compounds which liberate alkali in the heat, and also alkali metal silicates. Especially suitable are the alkali metal hydroxides and alkali metal salts of weak to medium inorganic or organic acids, the preferred alkali metal compounds being the sodium and potassium compounds. Such acid-binding agents are for example sodium hydroxide, potassium hydroxide, sodium carbonate, sodium bicarbonate, potassium carbonate, sodium formate, sodium dihydrogenphosphate, disodium hydrogenphosphate, sodium trichloroacetate, trisodium phosphate or waterglass or mixtures thereof, for example mixtures of aqueous sodium hydroxide solution and waterglass.

The dye mixtures according to the invention are notable for outstanding color strength when applied to the cellulose fiber materials by dyeing or printing processes.

The dyeing and prints obtainable with the dye mixtures according to the invention possess bright shades; more particularly, the dyeings and prints on cellulose fiber materials possess very good lightfastness and especially good wetfastnesses, such as fastness to washing, milling, water, seawater, crossdyeing and acidic and alkaline perspiration, also good fastness to pleating, hotpressing and rubbing. Furthermore, the cellulose dyeings obtained following the customary aftertreatment of rinsing to remove unfixed dye portions exhibit excellent wetfastnesses, in particular since unfixed dye portions are easily washed off because of their good solubility in cold water.

Furthermore, the dye mixtures according to the invention can also be used for the fiber-reactive dyeing of wool. Moreover, wool which has been given a nonfelting or low-felting finish (cf. for example H. Rath, Lehrbuch der Textilchemie, Springer-Verlag, 3rd edition (1972), pages 295-299, especially finished by the Hercosett process (page 298); J. Soc. Dyers and Colourists 1972, 93-99, and 1975, 33-44), can be dyed to very good fastness properties. The process of dyeing on wool is here carried out in a conventional manner from an acidic medium. For instance, acetic acid and/or ammonium sulfate or acetic acid and ammonium acetate or sodium acetate can be added to the dyebath to obtain the desired pH. To obtain a dyeing of acceptable levelness, it is advisable to add a customary leveling agent, for example a leveling agent based on a reaction product of cyanuric chloride with three times the molar amount of an aminobenzenesulfonic acid and/or of an aminonaphthalene-sulfonic acid or on the basis of a reaction product of for example stearylamine with ethylene oxide. For instance, the dye mixture according to the invention is preferably subjected to the exhaust process initially from an acidic dyebath having a pH of about 3.5 to 5.5 under pH control and the pH is then, toward the end of the dyeing time, shifted into the neutral and optionally weakly alkaline range up to a pH of 8.5 to bring about, especially for very deep dyeings, the full reactive bond between the dyes of the dye mixtures according to the invention and the fiber. At the same time, the dye portion not reactively bound is removed.

The procedure described herein also applies to the production of dyeings on fiber materials composed of other natural polyamides or of synthetic polyamides and polyurethanes. In general, the material to be dyed is introduced into the bath at a temperature of about 40° C., agitated therein for some time, the dyebath is then adjusted to the desired weakly acidic, preferably weakly acetic acidic, pH and the actual dyeing is carried out at a temperature between 60 and 98° C. However, the dyeings can also be carried out at the boil or in sealed dyeing apparatus at temperatures of up to 106° C. Since the water solubility of the dye mixtures according to the invention is very good, they can also be used with advantage in customary continuous dyeing processes.

The dye mixtures according to the invention dye the materials mentioned, preferably fiber materials, in navy to green shades having very good fastness properties.

The examples hereinbelow serve to illustrate the invention. Parts and percentages are by weight, unless otherwise stated. Parts by weight relate to parts by volume as the kilogram relative to the liter. The compounds described in the examples in terms of a formula are indicated in the form of the sodium salts, since they are generally prepared and isolated in the form of their salts, preferably sodium or potassium salts, and used for dyeing in the form of their salts. The starting compounds described in the examples hereinbelow, especially the table examples, can be used in the synthesis in the form of the free acid or likewise in the form of their salts, preferably alkali metal salts, such as sodium or potassium salts.

### EXAMPLE 1

70 parts of an electrolyte-containing dye powder which includes the greenish navy disazo dye of the formula (IA)

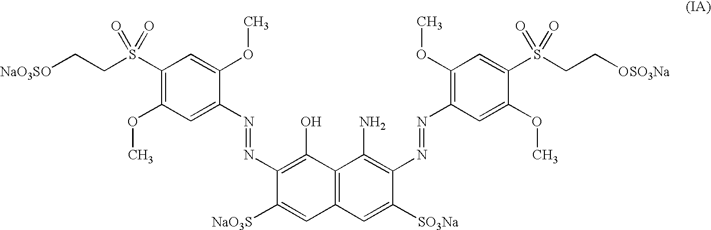

in a 70% fraction and 30 parts of an electrolyte-containing dye powder which includes the navy disazo dye of the formula (IIA) in a 75% fraction are mechanically mixed with each other.

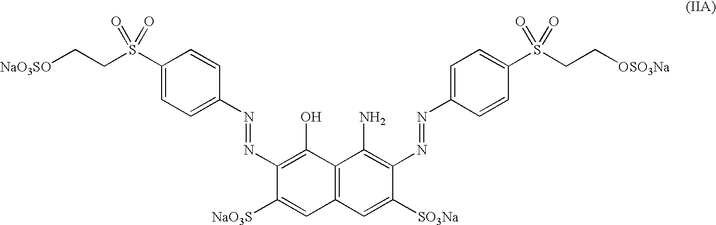

The resulting dye mixture according to the invention provides strong greenish navy dyeings and prints, on cotton for example, under the dyeing conditions customary for reactive dyes.

### EXAMPLE 2

60 parts of an electrolyte-containing dye powder which includes the greenish navy disazo dye of the formula (IA) in a 70% fraction and 40 parts of an electrolyte-containing dye powder which includes the navy disazo dye of the formula (IIB)

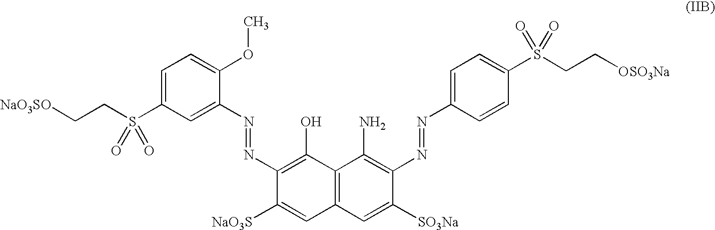

in a 75% fraction are dissolved in 500 parts of water and the resulting dye solution is adjusted to pH 5.5-6. Evaporation of this dye solution provides a dye mixture which provides strong greenish navy dyeings and prints on cotton under the dyeing conditions customary for reactive dyes.

### EXAMPLE 3

a) A mixture of 141 parts of 4-(β-sulfatoethylsulfonyl)aniline and 171 parts of 2,5-dimethoxy-4-(β-sulfatoethylsulfonyl)aniline is suspended in 750 parts of ice-water and 180 parts of 30% hydrochloric acid and diazotized by dropwise addition of 175 parts of 40% sodium nitrite solution. After excess nitrite has been removed by means of sulfamic acid solution, 319 parts of 1-amino-8-napahthol-3,6-disulfonic acid are added and coupled in a first step at pH 1 to 1.3 at below 20° C. to form a mixture of two red monoazo dyes conforming to the general formula (I). The stated pH range is set and maintained during the coupling reaction by addition of a total of about 140 parts of sodium bicarbonate.

b) In a second, separate reaction vessel, 325 parts of 2-methoxy-5-methyl-4-(β-sulfatoethylsulfonyl)aniline are suspended in 1 000 parts of ice-water and 180 parts of 30% hydrochloric acid and diazotized by dropwise addition of 175 parts of 40% sodium nitrite solution. After about 2 hours of subsequent stirring at 10-15° C., excess nitrite is reduced with sulfamic acid and the resulting diazo suspension is pumped into the mixture of the red monoazo dyes of a). The batch is then adjusted to pH 5-6 with sodium carbonate at below 25° C. and the 52:48 mixture of the dyes (IB) and (IIC) formed after the coupling reaction has ended is isolated by spray drying. Alternatively, the dye solution obtained can also be buffered at pH 5.5-6 by addition of a phosphate buffer and be adjusted by further dilution or concentration to provide a liquid brand of defined strength.

The resulting dye mixture according to the invention dyes cotton in strong greenish navy shades.

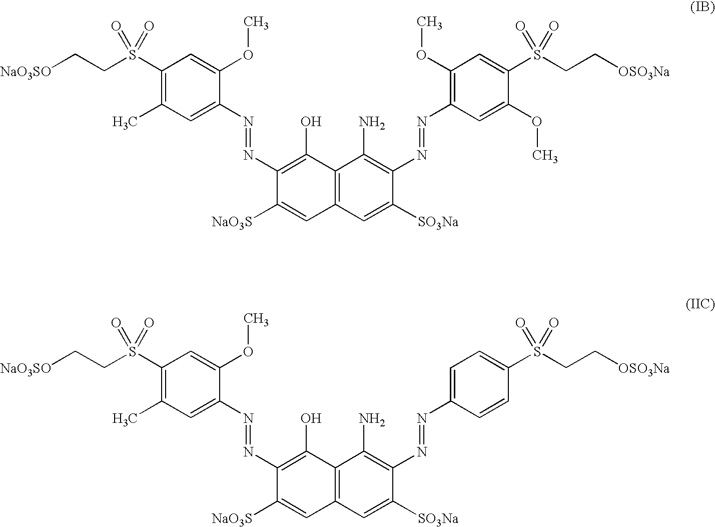

### EXAMPLE 4

a) A mixture of 141 parts of 4-(β-sulfatoethylsulfonyl)aniline and 171 parts of 2,5-dimethoxy-4-(β-sulfatoethylsulfonyl)aniline is diazotized as described in example 2a. 159 parts of 1-amino-8-naphthol-3,6-disulfonic acid and also 159 parts of 1-amino-8-naphthol-4,6-disulfonic acid are added and coupled in a first step at pH 1 to 1.3 at below 25° C. to form a mixture of red monoazo dyes conforming to the general formula (1). The stated pH range is set and maintained during the coupling reaction by means of sodium bicarbonate.

b) In a second, separate reaction vessel, 341 parts of 2,5-dimethoxy-4-(β-sulfatoethylsulfonyl)aniline are suspended in 1 000 parts of ice-water and 180 parts of 30% hydrochloric acid and diazotized by dropwise addition of 175 parts of 40% strength sodium nitrite solution. After subsequent stirring at 10-15° C. for about 2 hours, excess nitrite is reduced with sulfamic acid and the resulting diazo suspension is pumped into the mixture of the red monoazo dyes of a). The batch is then adjusted to pH 5-6 with sodium carbonate at below 25° C. and the 26:26:24:24 mixture of the four disazo dyes (IA), (IAA), (IID) and (IIAF) formed after the coupling reaction has ended is isolated by spray drying.

The resulting dye mixture according to the invention dyes cotton in greenish navy shades.

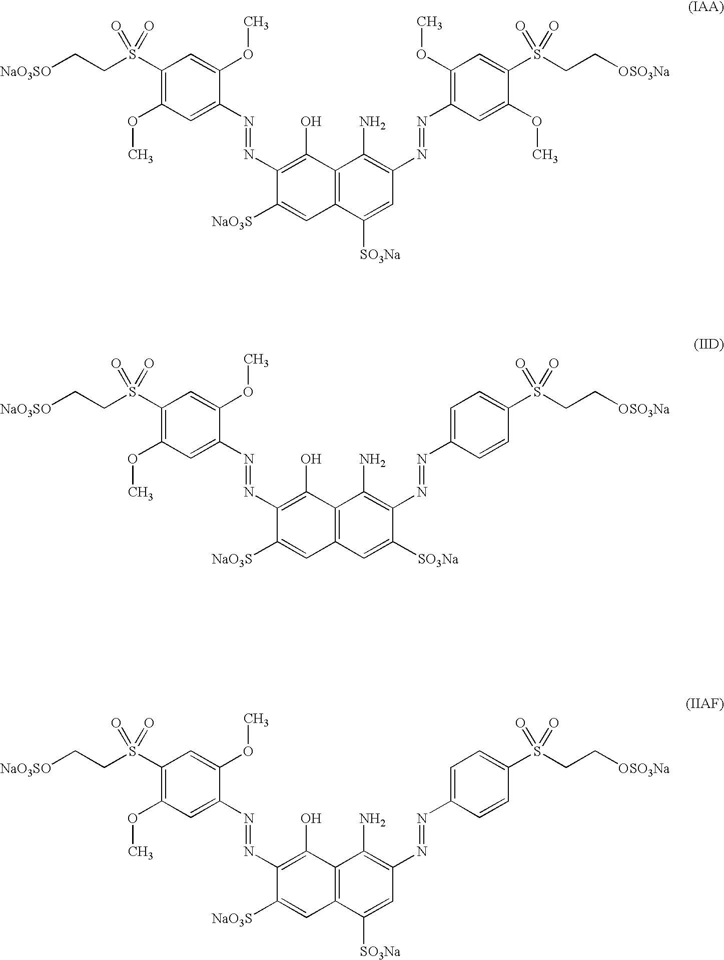

### EXAMPLES 5 TO 123

The table examples hereinbelow describe further inventive mixtures of dyes of the general formulae (I) and (II), each recited in the form of the sodium salt. The mixing ratios are indicated in percent by weight. The dye mixtures provide navy or greenish navy dyeings, on cotton for example, by the dyeing methods customary for reactive dyes.

Dye mixtures as per example 1 or 2

| | | | Ratio (I):(II); |
|---|---|---|---|
| Ex. | Dye of general formula (I) | Dye of general forula (II) | hue |
| 5 | (IA) | (IIA) | 18:85 |
| | | | navy |
| 6 | (IA) | (IIA) | 80:20 |
| | | | greenish navy |
| 7 | (IA) | (IIB) | 25:75 |
| | | | greenish navy |
| 8 | (IA) | (IIC) | 30:70 |
| | | | greenish navy |
| 9 | (IA) | 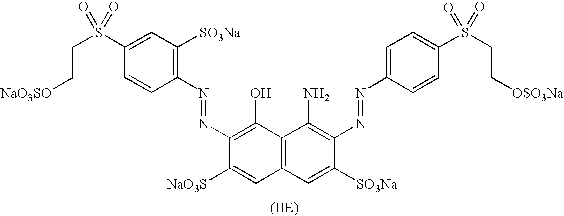 | 20:80 navy |
| 10 | (IA) | 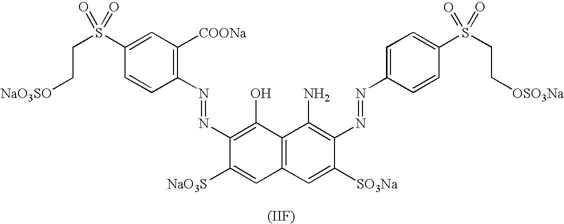 | 40:60 greenish navy |
| 10a | (IA) | 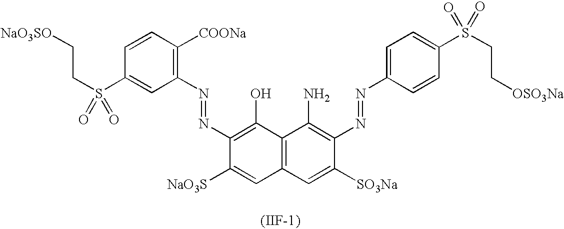 | 40:60 greeinch navy |
| 11 | (IA) | 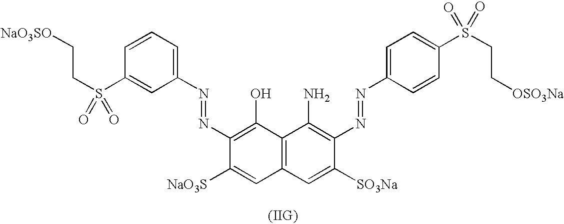 | 15:85 navy |
| 12 | (IA) | 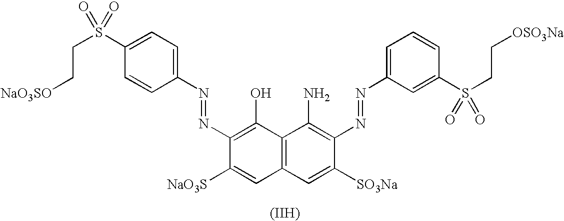 | 20:80 navy |
| 13 | (IA) | 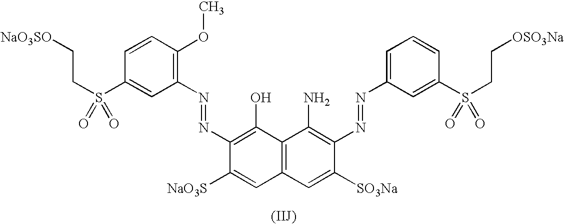 | 50:50 greenish navy |
| 14 | (IA) | 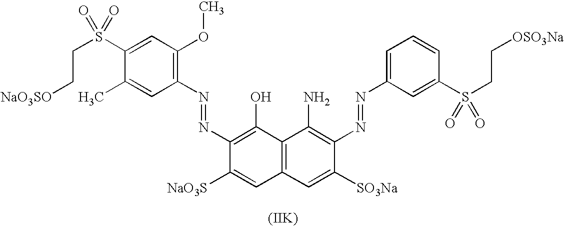 | 60:40 greenish navy |
| 15 | (IA) | 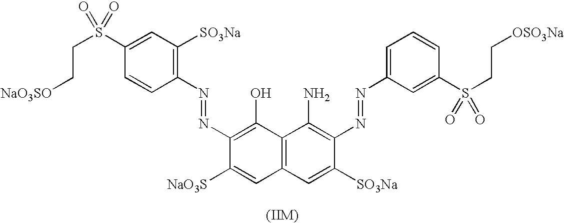 | 35:65 greenish navy |
| 16 | (A) | 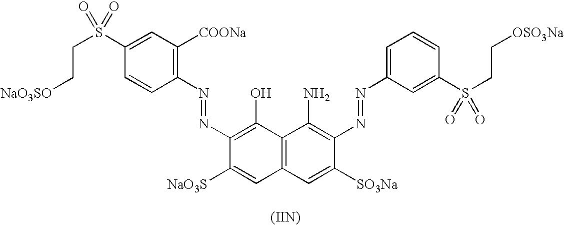 | 65:35 greenish navy |
| 16a | (IA) | 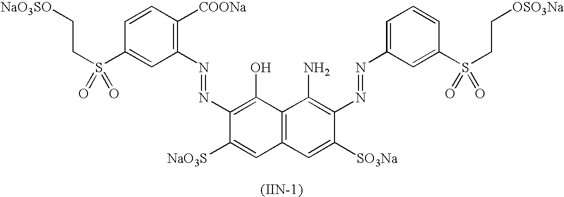 | 65:35 greenish navy |
| 17 | (IA) | 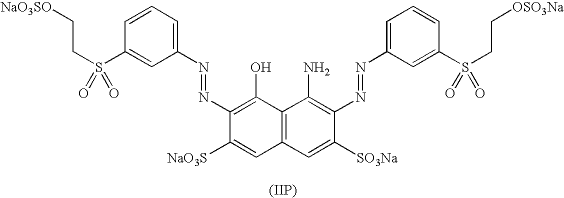 | 20:80 navy |
| 18 | (IA) | 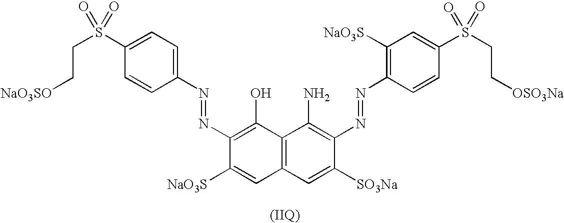 | 70:30 navy |
| 19 | (IA) | 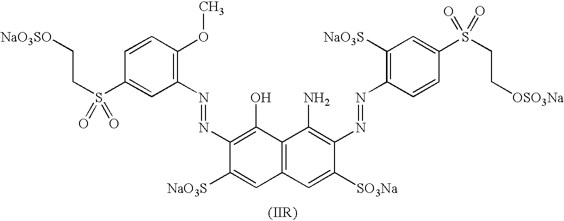 | 80:20 greenish navy |
| 20 | (IA) | 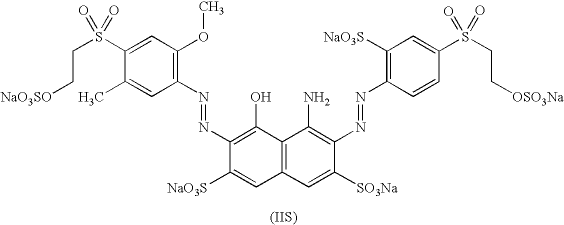 | 50:50 greenish navy |
| 21 | (IA) | 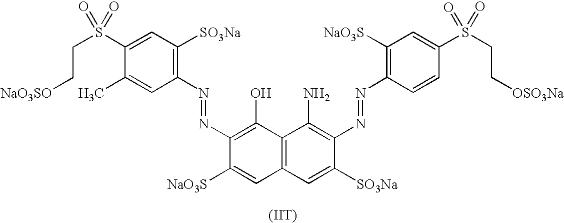 | 60:40 greenish navy |
| 22 | (IA) | 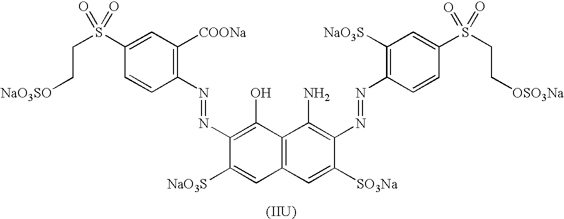 | 85:15 greenish navy |
| 22a | (IA) | 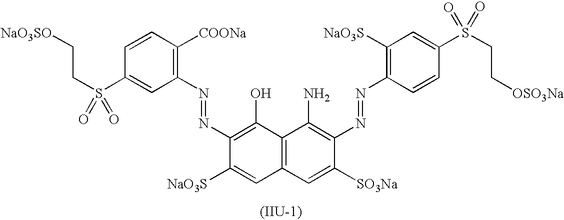 | 85:15 greenish navy |
| 23 | (IA) | 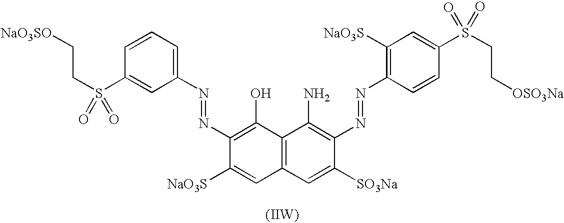 | 25:75 greenish navy |
| 24 | (IA) | 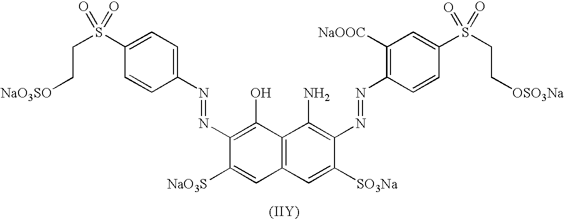 | 45:55 greenish navy |
| 24a | (IA) | 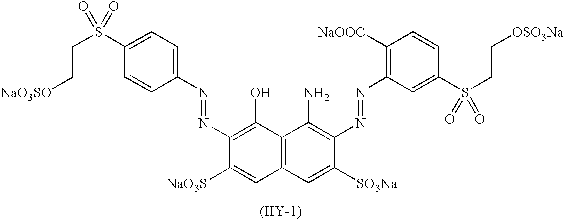 | 45:55 greenish navy |
| 25 | (IA) | 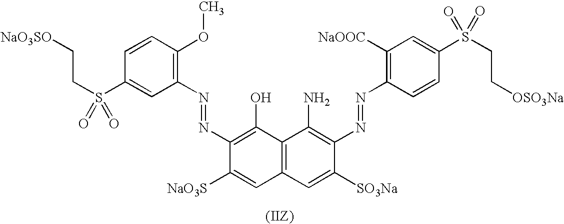 | 75:25 greenish navy |
| 25a | (IA) | 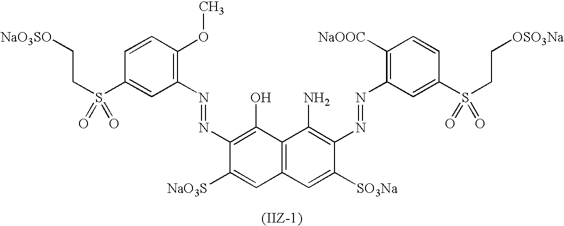 | 75:25 greenish navy |
| 26 | (IA) | 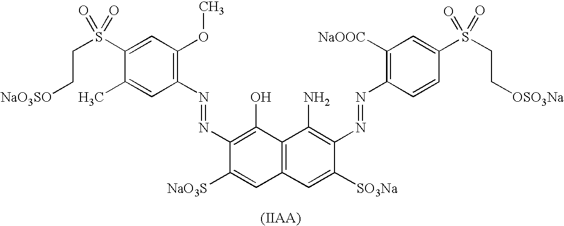 | 65:35 greenish navy |
| 26a | (IA) | 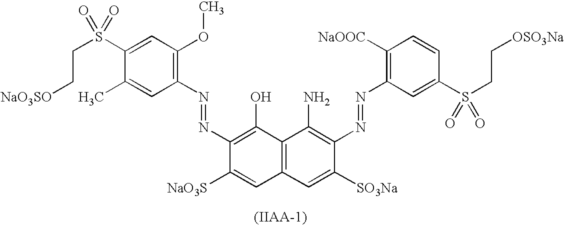 | 65:35 greenish navy |
| 27 | (IA) | 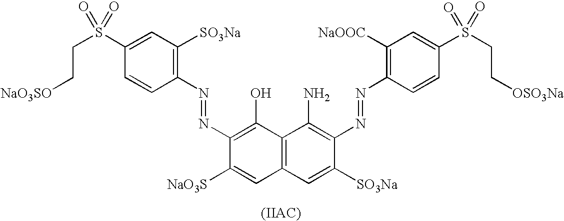 | 50:50 greenish navy |
| 27a | (IA) | 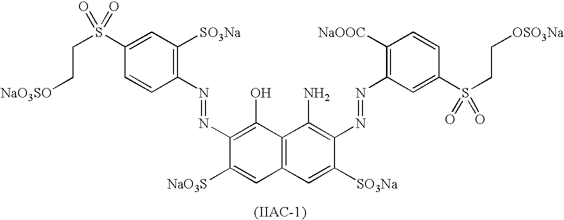 | 50:50 greenish navy |
| 28 | (IA) | 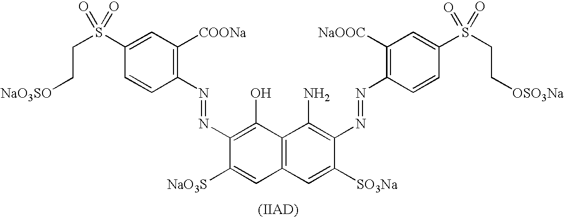 | 70:30 greenish navy |
| 28a | (IA) | 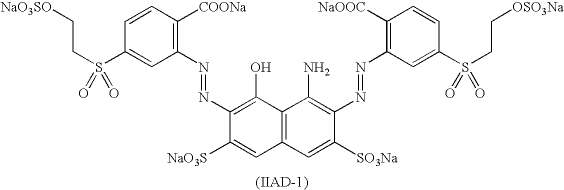 | 70:30 greenish navy |
| 29 | (IA) | 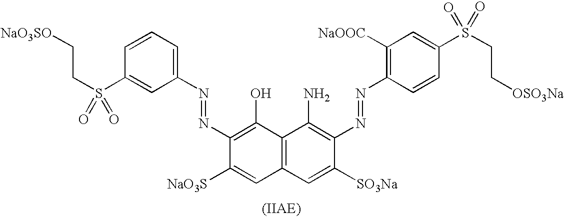 | 45:55 greenish navy |
| 29a | (IA) | 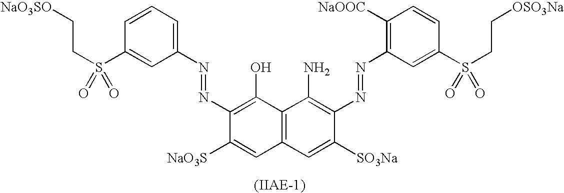 | 45:55 greenish navy |
| 30 | 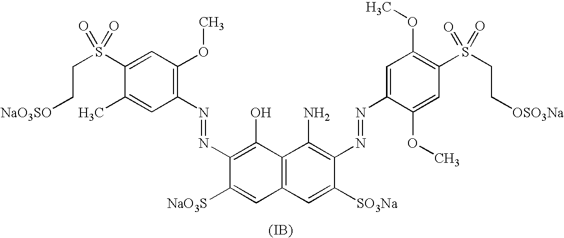 | (IIA) | 20:80 navy |
| 31 | (IB) | (IIB) | 50:50 |
| | | | greenish navy |
| 32 | (IB) | (IID) | 15:85 |
| | | | greenish navy |
| 33 | (IB) | (IIE) | 40:60 |
| | | | greenish navy |
| 34 | (IB) | (IIP) | 30:70 |
| | | | greenish navy |
| 35 | 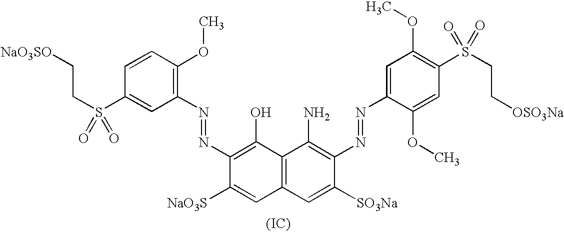 | (IIA) | 25:75 greenish navy |
| 36 | (IC) | (IID) | 30:70 |
| | | | greenish navy |
| 37 | (IC) | (IIE) | 35:65 |
| | | greenish navy | |
| 38 | 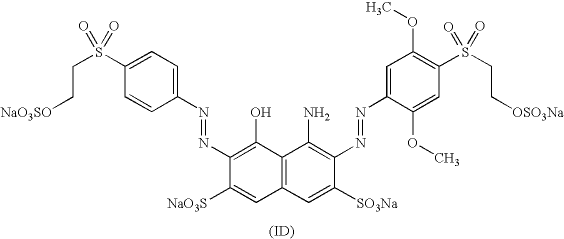 | (IIB) | 25:75 navy |
| 39 | (ID) | (IID) | 35:65 |
| | | | greenish navy |
| 40 | (ID) | (IIE) | 45:55 |
| | | | greenish navy |
| 41 | 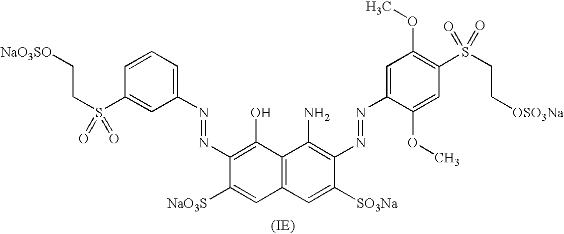 | (IIA) | 30:70 navy |
| 42 | (IE) | (IIB) | 50:50 |
| | | | greenish navy |
| 43 | (IE) | (IID) | 50:50 |
| | | | greenish navy |
| 44 | (IE) | (IIE) | 20:80 |
| | | | navy |
| 45 | 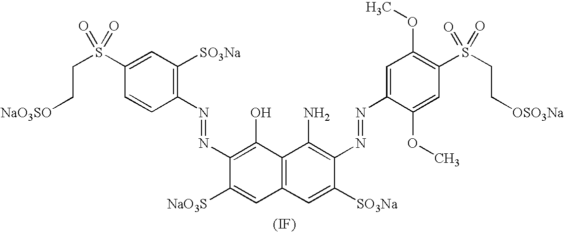 | (IIA) | 10:90 navy |
| 46 | (IF) | (IIB) | 50:50 |
| | | | greenish navy |
| 47 | (IF) | (IID) | 30:70 |
| | | | greenish navy |
| 48 | 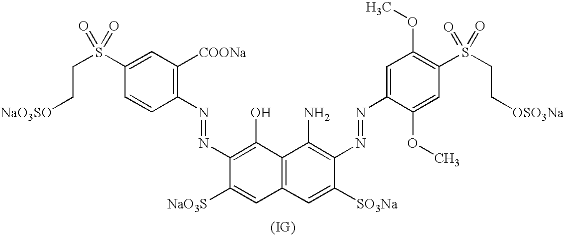 | (IIA) | 15:85 navy |
| 48a | 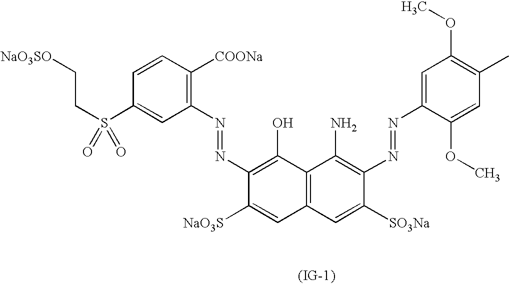 | (IIA) | 15:85 navy |
| 49 | (IG) | (IIB) 30:70 | |
| | | | greenish navy |
| 49a | (IG-1) | (IIB) | 30:70 |
| | | | greenish navy |
| 50 | (IG) | (IID) | 45:55 |
| | | | greenish navy |
| 50a | (IG-1) | (IID) | 45:55 |
| | | | greenish navy |
| 51 | (IG) | (IIE) | 25:75 |
| | | | navy |
| 51a | (IG-1) | (IIE) | 25:75 |
| | | | navy |
| 52 | 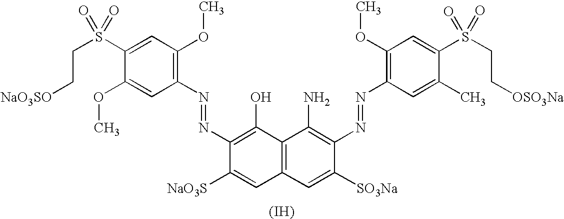 | (IA) | 30:70 greenish navy |
| 53 | (IH) | (IIB) | 40:60 |
| | | | greenish navy |
| 54 | (IH) | (IIE) | 20:80 |
| | | | navy |
| 55 | (IH) | (IIP) | 25:75 |
| | | | greenish navy |
| 56 | 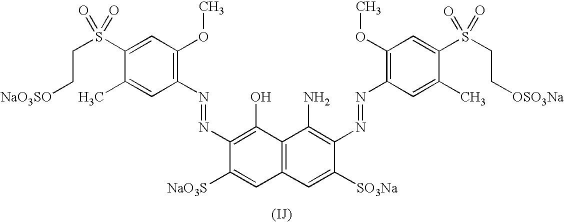 | (IIA)( | 25:75 greenish navy |
| 57 | (IJ) | (IIB) | 20:80 |
| | | | greenish navy |
| 58 | (IJ) | (IID) | 50:50 |
| | | | greenish navy |
| 59 | (IJ) | (IIE) | 30:70 |
| | | | greenish navy |
| 60 | (IJ) | (IIP) | 35:65 |
| | | | greenish navy |
| 61 | 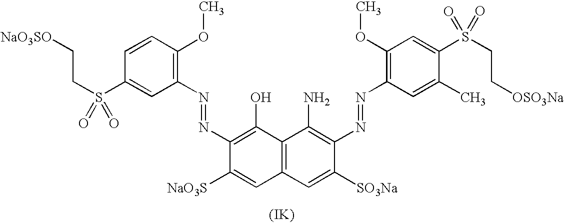 | (IIA) | 30:70 greenish navy |
| 62 | (IK) | (IID) | 25:75 |
| | | | greenish navy |
| 63 | (IK) | (IIE) | 40:60 |
| | | | greenish navy |
| 64 | 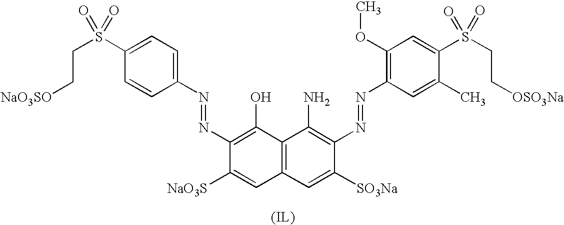 | (IIB) | 50:50 greenish navy |
| 65 | (IL) | (IID) | 25:75 |
| | | | greenish navy |
| 66 | (IL) | (IIE) | 30:70 |
| | | | greenish navy |
| 67 | 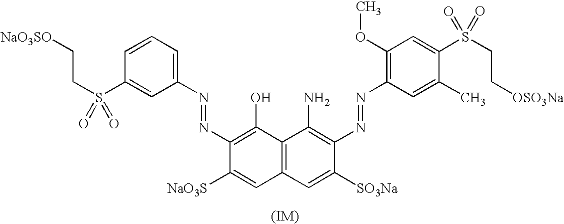 | (IIA) | 20:80 navy |
| 68 | (IM() | (IIB) | 40:60 |
| | | | greenish navy |
| 69 | (IM) | (IID) | 50:50 |
| | | | greenish navy |
| 70 | (IM) | (IIE) | 35:65 |
| | | | greenish navy |
| 71 | 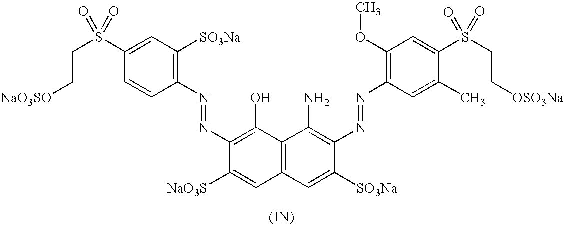 | (IIA) | 15:85 navy |
| 72 | (IN) | (IIB) | 25:75 |
| | | | greenish navy |
| 73 | (IN) | (IID) | 40:60 |
| | | | greenish navy |
| 74 | 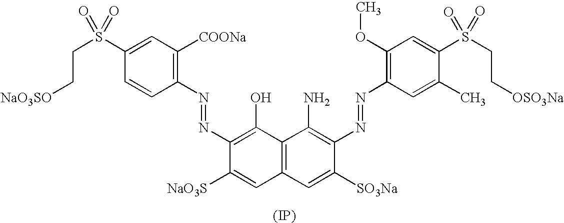 | (IIA) | 40:60 greenish navy |
| 74a | 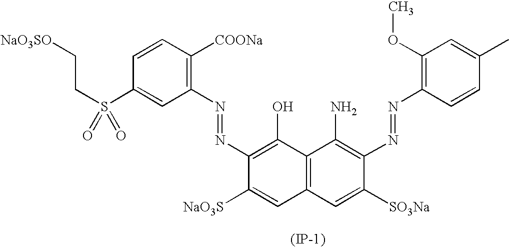 | (IIA) | 40:60 greenish navy |
| 75 | (IP) | (IIB) | 30:70 |
| | | | greenish navy |
| 75a | (IP-1) | (IIB) | 30:70 |
| | | | greenish navy |
| 76 | (IP) | (IID) | 20:80 |
| | | | greenish navy |
| 76a | (IP-1) | (IID) | 20:80 |
| | | | greenish navy |
| 77 | (IP) | (IIE) | 35:65 |
| | | | greenish navy |
| 77a | (IP-1) | (IIE) | 35:65 |
| | | | greenish navy |
| 78 | 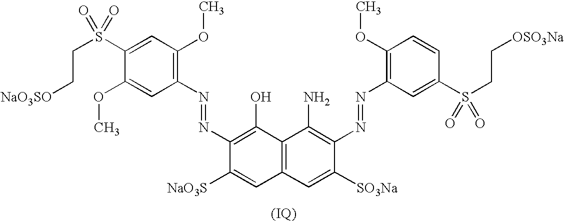 | (IIA) | 30:70 greenish navy |
| 79 | (IQ) | (IIB) | 50:50 |
| | | | greenish navy |
| 80 | (IQ) | (IIE) | 25:75 |
| | | | greenish navy |
| 81 | 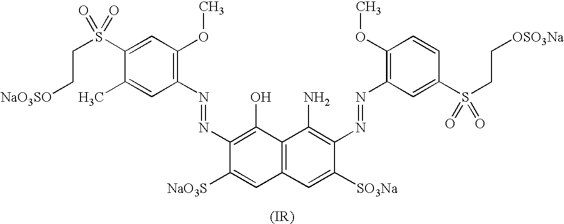 | (IIA) | 40:60 greenish navy |
| 82 | (IR) | (IIB) | 20:80 |
| | | | greenish navy |
| 83 | (IR) | (IID) | 20:80 |
| | | | grenish navy |
| 84 | (IR) | (IIE) | 30:70 |
| | | | greenish navy |
| 85 | 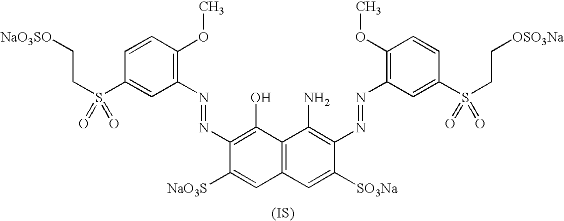 | (IIA) | 20:80 navy |
| 86 | (IS) | (IID) | 25:75 |
| | | | greenish navy |
| 87 | (IS) | (IIE) | 15:85 |
| | | | navy |
| 88 | (IAA) | (IIA) | 20:80 |
| | | | navy |
| 89 | 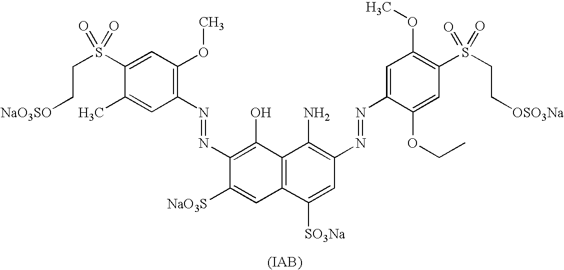 | (IIA) | 30:70 greenish navy |
| 89 | 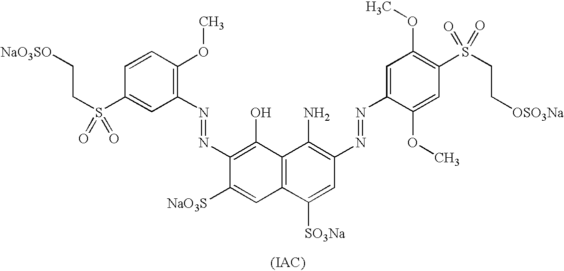 | (IIA) | 40:60 greenish navy |
| 90 | 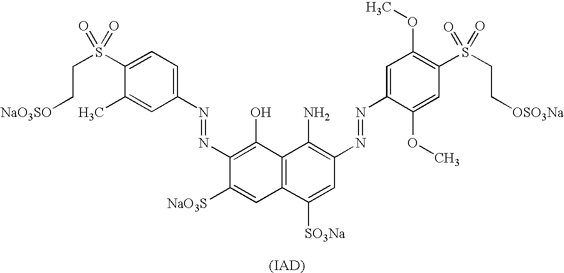 | (IID) | 25:75 greenish navy |
| 91 | 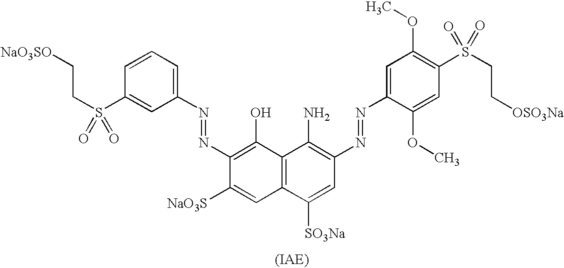 | (IIA) | 50:50 greenish navy |
| 92 | 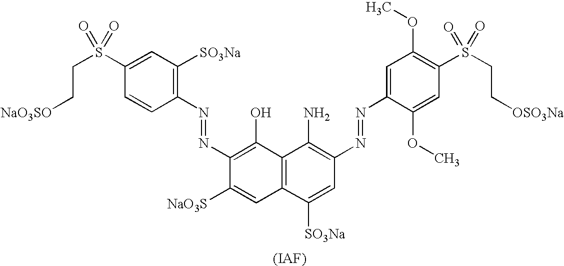 | (IIA) | 20:80 navy |
| 93 | 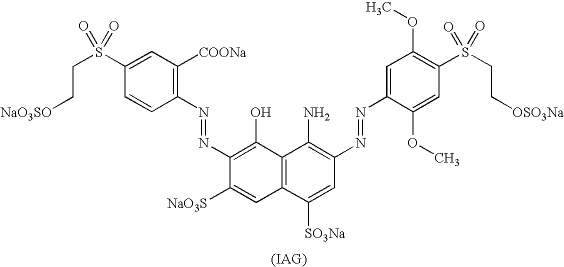 | (IIA) | 25:75 navy |
| 93a | 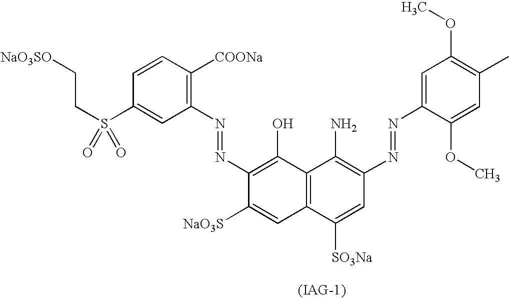 | (IIA) | 25:75 navy |
| 94 | 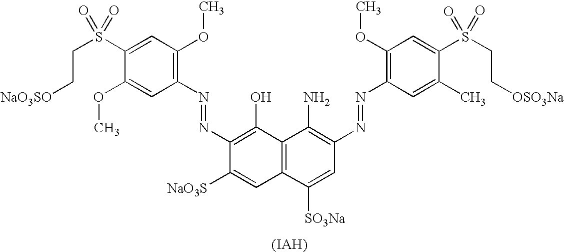 | (IIA) | 40:60 greenish navy |
| 95 | 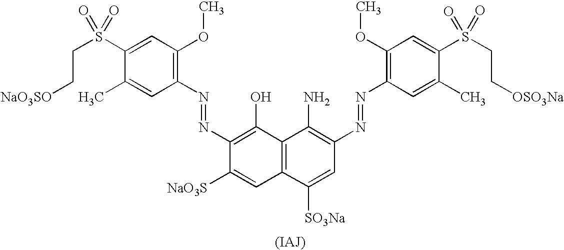 | (IIA) | 30:70 greenish navy |
| 96 | 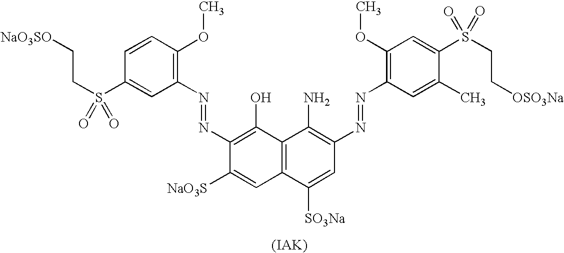 | (IIA) | 20:80 greenish navy |
| 97 | 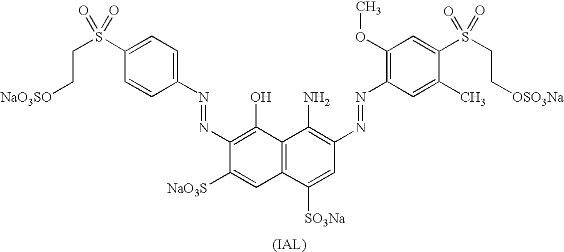 | (IIC) | 30:70 greenish navy |
| 98 | 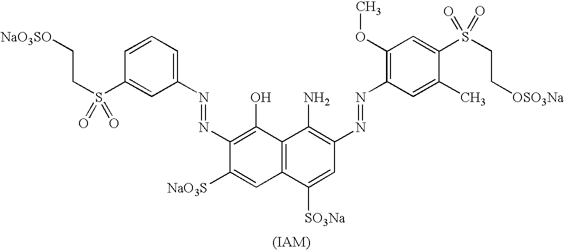 | (IIA) | 25:75 greenish navy |
| 99 | 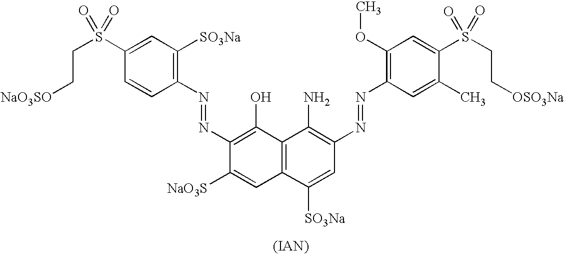 | (IIA) | 40:60 greenish navy |
| 100 | 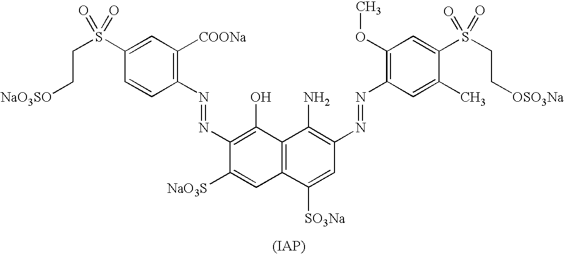 | (IIA) | 40:60 greenish navy |
| 101 | 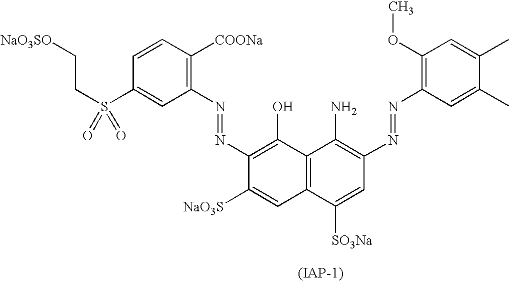 | (IIA) | 40:60 greenish navy |
| 101 | 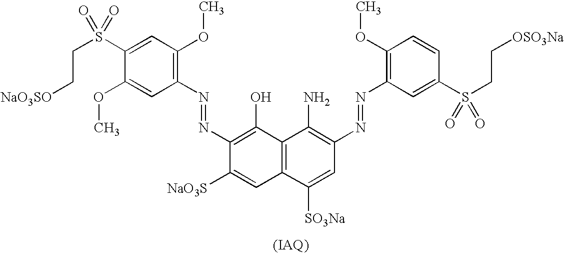 | (IIA) | 30:70 greenish navy |
| 102 | 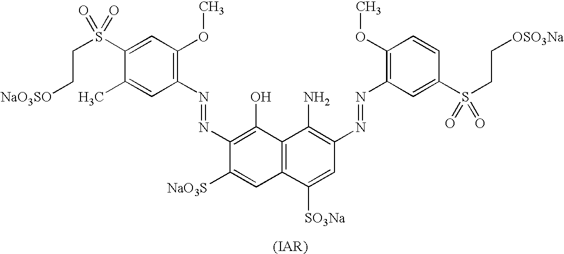 | (IIA) | 40:60 greenish navy |
| 103 | 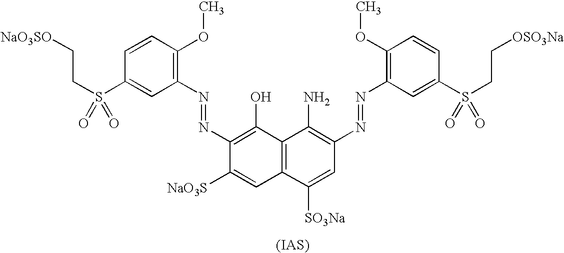 | (IIA) | 35:65 navy |

Dye mixtures as per example 3

| Exam- | Dye of general | | Ratio (I):(II); |
|---|---|---|---|
| ple | formula (I) | Dye of general formula (II) | hue |
| 104 | (IA) | (IID) | 20:80 |
| | | | greenish navy |
| 105 | (IA) | 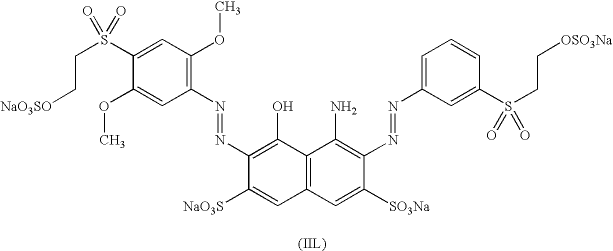 | 75:25 greenish navy |
| 106 | (IA) | 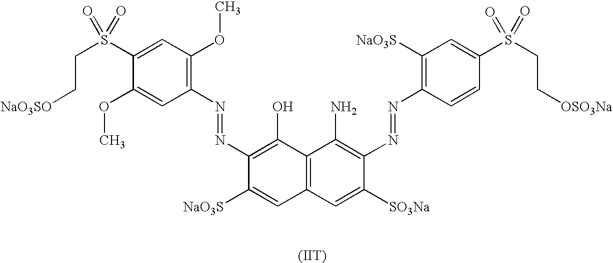 | 90:10 greenish navy |
| 107 | (IA) | 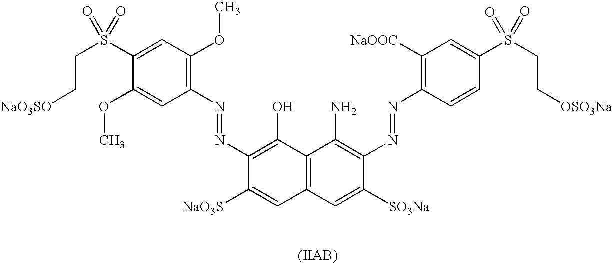 | 80:20 greenish navy |
| 107a | (IA) | 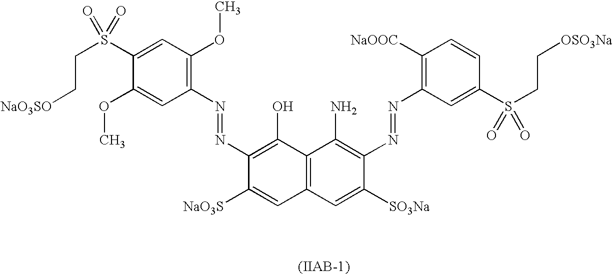 | 80:20 greenish navy |
| 108 | (IB) | (IIC) | 50:50 |
| | | | greenish navy |
| 109 | (IC) | (IIB) | 35:65 |
| | | | greenish navy |
| 110 | (ID) | (IIA) | 20:80 |
| | | | navy |
| 111 | (IE) | (IIP) | 40:60 |
| | | | greenish navy |
| 112 | (IF) | (IIE) | 40:60 |
| | | | greenish navy |
| 113 | (IH) | (IID) | 35:65 |
| | | | greenish navy |
| 114 | (IJ) | (IIC) | 45:55 |
| | | | greenish navy |
| 115 | (IK) | (IIB) | 20:80 |
| | | | greenish navy |
| 116 (IL) | (IIA) | 20:80 | |
| | | | navy |
| 117 | (IM) | (IIP) | 25:75 |
| | | | greenish navy |
| 118 | (IN) | (IIP) | 45:55 |
| | | | greenish navy |
| 119 | (IQ) | (IID) | 35:65 |
| | | | greenish navy |
| 120 | (IR) | (IIC) | 45:55 |
| | | | greenish navy |
| 121 | (IS) | (IIB) | 50:50 |
| | | | greenish navy |
| 122 | (IAD) | (IIA) | 45:55 |
| | | | greenish navy |
| 123 | (IAL) | (IIA) | 35:65 |
| | | | greenish navy |

Use Example

3 parts of a dye obtained according to example 1-4 and 50 parts of sodium chloride are dissolved in 999 parts of water and 5 parts of sodium carbonate, 1 part of sodium hydroxide (in the form of a 32.5% aqueous solution) and optionally 1 part of a wetting agent are added. This dyebath is entered with 100 g of a cotton fabric. The temperature of the dyebath is first maintained at 25° C. for 10 minutes, then raised over 30 minutes to the final temperature (40-60° C.) and maintained at that temperature for a further 60-90 minutes. Thereafter, the dyed fabric is rinsed initially with tap water for 2 minutes and then with ion-free water for 5 minutes. The dyed fabric is neutralized at 40° C. in 1000 parts of an aqueous solution containing I part of 50% acetic acid for 10 minutes. It is subsequently rinsed with ion-free water at 70° C. and thereafter soaped off at the boil with a detergent for 15 minutes, rinsed once more and dried. This gives a strong navy to greenish navy dyeing having very good fastness properties.

What is claimed is:

1. Reactive dye mixtures including one or more disazo dyes of the hereinbelow indicated and defined general formula (I) 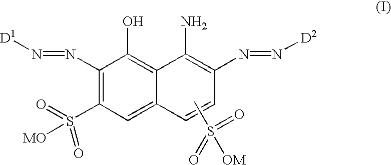
and one or more disazo dyes of the hereinbelow indicated and defined general formula (II) 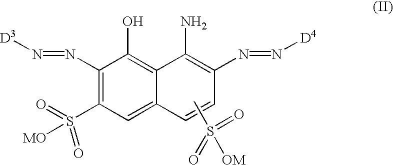
where
D¹ is a group of the general formula (I-1) and D² is a group of the general formula (I-2) 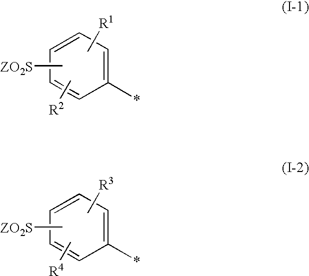
D³ is a group of the general formula (II-1) and D⁴ is a group of the general formula (II-2) 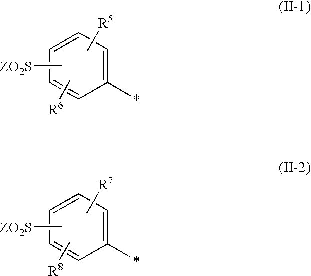
where
R¹ and R² are independently hydrogen, (C₁-C₄)-alkyl, (C₁-C₄)-alkoxy, sulfo or carboxyl;
R³ is hydrogen, (C₁-C₄)-alkyl or (C₁-C₄)-alkoxy;
R⁴ is (C₁-C₄)-alkyl or (C₁-C₄)-alkoxy;
R⁵, R⁶, R⁷ and R⁸ are independently hydrogen, (C₁-C₄)-alkyl, (C₁-C₄)-alkoxy, hydroxyl, sulfo, carboxyl, cyano, nitro or halogen;
Z is —CH₂CH₂Z¹ or —CH═CH₂, where
Z¹ is an alkali-detachable group or hydroxyl; and
M is hydrogen, an alkali metal or one equivalent of an alkaline earth metal.

2. Reactive dye mixtures as claimed in claim 1, wherein R¹, R² and R⁵ to R⁸ are each hydrogen, methyl, methoxy, sulfo or carboxyl, R³ is hydrogen, methyl or methoxy and R⁴ is methoxy.

3. Reactive dye mixtures as claimed in at least one of claims 1 and 2, wherein Z is vinyl, β-chloroethyl or β-sulfatoethyl.

4. Reactive dye mixtures as claimed in at least one of claims 1 to 3, including at least one dye of the general formula (Ia) 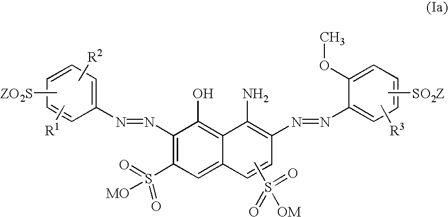
and at least one dye of the general formula (IIa) 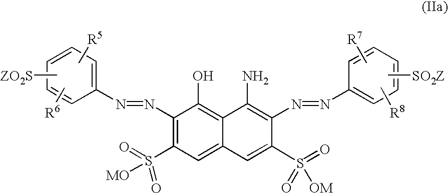
where M, R¹ to R³, R⁵ to R⁸ and Z are each as defined in claim 1.

5. A reactive dye mixture as claimed in claim 4, wherein R¹ to R³ are independently hydrogen, methyl or methoxy in the formula (Ia), R⁵ to R⁵ are independently hydrogen, methyl, methoxy, sulfo or carboxyl in the formula (IIa) and Z is vinyl or β-sulfatoethyl in the formulae (Ia) and (IIa).

6. A reactive dye mixture as claimed in claim 4, wherein R¹ to R³ are each methyl or methoxy in the formula (Ia), R⁵ and R⁶ are each hydrogen, methoxy or sulfo and R⁷ and R⁸ are each hydrogen in the formula (IIa) and Z is vinyl or β-sulfatoethyl in the formulae (Ia) and (IIa).

7. A reactive dye mixture as claimed in claim 4, wherein R¹ to R³ are each methyl or methoxy in the formula (Ia), R⁵ to R⁸ are each hydrogen in the formula (IIa) and Z is vinyl or β-sulfatoethyl in the formulae (Ia) and (IIa).

8. Reactive dye mixtures as claimed in one or more of claims 1 to 7, including one or more dyes of the formula (I) in a fraction of 5 to 95% by weight and one or more dyes of the formula (II) in a fraction of 5 to 95% by weight.

9. Reactive dye mixtures as claimed in claim 1, including one or more monoazo dyes of the formula (1) and/or one or more monoazo dyes of the formula (2) each at 0.5 to 8% by weight 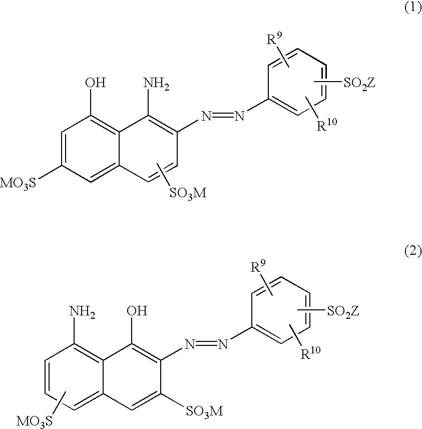
where M and Z are each as defined in claim 1, R⁹ has one of the meanings of R³ or R⁷ and R¹⁰ each have one of the meanings of R⁴ or R⁸, the meanings indicated in claim 1 applying in each case.

10. A process for producing dye mixtures as claimed in one or more of claims 1 to 9, which comprises the individual dyes of the formulae (I) and (II) being mixed with each other in the required proportions either mechanically in solid form or in the form of aqueous solutions.

11. A process for producing dye mixtures as claimed in one or more of claims 1 to 9, for the case where R¹ and R⁵ and also R² and R⁶ in the general formulae (I-1) and (II-1) are the same, which comprises diazotizing a mixture of amines of the general formulae (3a) and (3b) 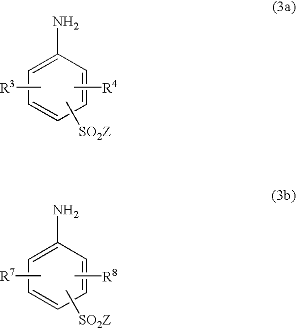
where R³, R⁴, R⁷, R⁸ and Z are each as defined in claim 1, in a conventional manner and reacting the resulting mixture of diazonium compounds with 1-amino-8-hydroxynaphthalene-3,6-disulfonic acid or 1-amino-8-hydroxynaphthalene-4,6-disulfonic acid in an acidic medium in a first step to form a mixture of monoazo dyes and subsequently diazotizing an amine of the general formula (3c) 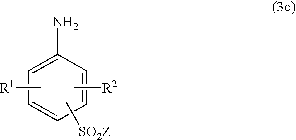
where R¹, R² and Z are each as defined in claim 1, in a conventional manner and coupling the resulting diazonium compound onto the mixture of monoazo compounds which was obtained beforehand in the first step.

12. Use of reactive dye mixtures as set forth in one or more of claims 1 to 11 for dyeing hydroxyl- and/or carboxamido-containing fiber material.
